(19) United States
(12) Patent Application Publication
(10) Pub. No.: US 2026/0307624 A1
(43) Pub. Date: Oct. 8, 2026

(54) CLEANING ASSEMBLY FOR MOTOR VEHICLE SENSORS

(71) Applicant: VALEO SYSTEMES D'ESSUYAGE, La Verriere (FR)

(72) Inventors: Nicolas HORNYCH, La Verriere (FR); Denis THEBAULT, La Verriere (FR)

(73) Assignee: VALEO SYSTEMES D'ESSUYAGE, La Verriere (FR)

(21) Appl. No.: 18/998,575

(22) PCT Filed: Jul. 12, 2023
(86) PCT No.: PCT/EP2023/069330

§ 371 Date: Jan. 27, 2025

(30) Foreign Application Priority Data
Jul. 27, 2022 (FR) FR2207725

(51) Int. Cl. B60S 1/56; B60S 1/52; B60S 1/54

(52) U.S. Cl. CPC B60S 1/56; B60S 1/52; B60S 1/54

(57) ABSTRACT

The invention relates to a clever geometry for a housing of a sensor, such as a LIDAR, and a cleaning boom which is used to project a fluid used to clean an optical surface of the housing or of the sensor. The cleaning boom is not adhesively bonded to the optical surface, but situated at a distance from the optical surface, such that there is a non-zero clearance, forming a slot, between the cleaning boom and the optical surface in order for the projected fluid flowing on the optical surface to be able to be discharged from the optical surface by flowing through the slot thus formed.

### TECHNICAL FIELD

The technical context of the present invention is that of onboard sensors in motor vehicles and devices for cleaning an optical surface through which said sensors carry out their measurements. More particularly, the invention relates notably to a cleaning assembly for a motor vehicle.

### BACKGROUND OF THE INVENTION

In general, the present invention relates to a cleaning assembly which makes it possible to clean bodies which are in contact with the optical surface of the sensor. In this case, “clean” is understood to mean that the cleaning assembly is configured to remove bodies which were present in contact with the optical surface such that, after the cleaning operation, the optical surface is free from said bodies.

In the prior art, numerous cleaning assemblies which make it possible to clean the optical surface of sensors are known. Such cleaning assemblies comprise at least one sensor, an optical surface situated in front of the at least one sensor, relative to a direction of propagation of a signal emitted or received by said at least one sensor, and a cleaning boom configured to project a fluid onto the optical surface.

As is known, the discharge of the projected fluid is vital for simultaneously ensuring proper operation of the sensor and proper cleaning of the optical surface. This discharge can be carried out in two ways. First, in the case of the presence of sufficient relative wind at the optical surface, resulting for example from a travel speed of the motor vehicle and/or from wind flowing around the motor vehicle, then the projected fluid present on the optical surface is pushed toward an edge of the optical surface by the relative wind. As an alternative, if the relative wind is insufficient, the projected fluid present on the optical surface can flow toward a lower edge of the optical surface by the simple effect of gravity.

Such cleaning assemblies have a major drawback which lies in the discharge of the fluid projected by the cleaning boom from the optical surface. Specifically, the geometry of the optical surface and/or of the sensor and/or the presence of technical components in the immediate vicinity can compromise or even prevent correct and complete discharge of the fluid flowing on the optical surface.

By way of example, document US2020023814A1 is known, which describes a cleaning assembly comprising a housing comprising at least one peripheral lateral wall that is substantially perpendicular with respect to a side of a vehicle to which the housing is fastened, a cover and a vision system comprising at least one sensor housed inside the housing. The cleaning assembly further comprises an optical surface movably in front of the sensor in order to be able to be inclined toward the inside and toward the rear of the housing, and at least one spray nozzle configured to project a cleaning liquid onto the optical surface. Thus, the cleaning assembly described in document US2020023814A1 makes it possible, in the case of sufficient relative wind, to discharge the cleaning liquid from the optical surface by inclining the latter toward the rear in order to allow the cleaning liquid to be discharged from said optical surface. By contrast, in the case of insufficient relative wind, the cleaning liquid projected onto the optical surface falls by gravity to a base of the cleaning assembly and accumulates there.

Such an accumulation is not desirable because it can lead to accumulation and deposition of particles at the base, or even infiltration of the cleaning liquid in the vicinity of the base of the cleaning assembly.

Another drawback of the cleaning assembly described in document US2020023814A1 results from its implementation complexity and the need to control an actuation of the optical surface in order to discharge an excess of cleaning liquid.

### SUMMARY OF THE INVENTION

An object of the present invention is to propose a novel cleaning assembly in order to at least largely address the problems above and also to lead to other advantages.

Another aim of the invention is to enable better discharge of the fluid projected onto the optical surface.

Another aim of the invention is to propose a technical solution that is simple to implement, robust and reliable.

Another aim of the invention is to propose an economical solution.

According to a first aspect of the invention, at least one of the aforementioned objectives is achieved with a cleaning assembly for a motor vehicle, the cleaning assembly comprising (i) at least one sensor, (ii) an optical surface situated in front of the at least one sensor, relative to a direction of propagation of a signal emitted and/or received by said at least one sensor, (iii) a cleaning boom configured to project a fluid onto the optical surface, Particularly advantageously, in the cleaning assembly according to the first aspect of the invention, the cleaning boom is disposed at a distance from the optical surface so as to allow the fluid to flow between the at least one sensor and the cleaning boom.

In the context of the invention, the at least one sensor is a sensor of the type of those used in the field of motor vehicles, in order for example to detect a road scenario, detect an obstacle, measure a speed. By way of non-limiting examples, the at least one sensor may take the form of an optical remote-sensing apparatus, such as a LIDAR, of a photographic apparatus, of a camera, of a radar, of an infrared sensor or of an ultrasound rangefinder. According to a particularly advantageous aspect of the invention, the at least one sensor takes the form of a LIDAR, standing for Laser Imaging Detection and Ranging, meaning laser-based remote sensing.

In the context of the invention, the optical surface takes the form of a surface that is transparent with respect to the emitted and/or received signal, thus allowing said signal to pass through the optical surface. In the context of the invention, the optical surface may take the form of a planar or curved surface that is textured or smooth. Preferably, the optical surface is planar and smooth. The optical surface may be formed of a transparent plastic material or of a transparent glass material.

In the context of the invention, for a surface or a material the transparency is understood to be a capacity to allow the signal emitted and/or received by the at least one sensor to propagate in and/or through said surface or said material. More particularly, the optical surface and/or the material used to form said optical surface allow a light signal to pass through, the spectrum of which is within the infrared range.

In the context of the invention, the cleaning boom is a cleaning system which makes it possible to clean the optical surface by projecting at least one liquid or gaseous fluid on top thereof. The cleaning boom extends transversely to the optical surface in order to allow the fluid to be projected over all or part of the optical surface, and preferably at least over a central zone of the optical surface corresponding to the field of view of the at least one sensor. To this end, the cleaning boom comprises a strip, the position and orientation of which with respect to the at least one sensor and to the optical surface are predefined in order to allow the fluid to be effectively projected onto the optical surface. The cleaning boom is situated in front of the at least one sensor, without overlapping the field of view of the at least one sensor. In general, in a transverse plane perpendicular to the optical surface, the cleaning boom is situated between an upper edge and a lower edge of said optical surface. This advantageous configuration makes it possible to effectively project the fluid onto the largest part of the optical surface. Of course, in accordance with the invention, there is a non-zero distance between an edge of the cleaning boom facing the lower edge of the optical surface and said lower edge of said optical surface and/or there is a non-zero distance between an edge of the cleaning boom facing the upper edge of the optical surface and said upper edge of said optical surface.

In the context of the invention, the cleaning system comprises a reservoir, a pump and at least one diffusion nozzle configured to project the fluid onto the optical surface. Depending on the dimensions of the optical surface, the cleaning system may comprise one or more diffusion nozzles. Potentially, the cleaning boom comprises at least one diffusion nozzle that is movable in translation along said cleaning boom and set in motion by an actuator. As an alternative, the cleaning boom comprises one or more static diffusion nozzles. Advantageously, the cleaning boom incorporates the at least one diffusion nozzle, each at least one diffusion nozzle being fluidically coupled to the reservoir and to the pump by way of a distribution line secured to the cleaning boom.

Particularly advantageously, the cleaning boom is not adhesively bonded against the optical surface. By contrast, the cleaning boom is situated at a distance from the optical surface, such that there is a non-zero clearance between a facing face of the cleaning boom proximal to the optical surface and said optical surface,

Thus, the invention, according to the first aspect, solves the technical problem in that the placing of the cleaning boom at a distance from the optical surface allows the fluid projected onto said optical surface to be discharged, and does not allow said fluid to accumulate in the vicinity of the cleaning boom.

In addition, the cleaning assembly according to the first aspect of the invention proposes a technical solution that is simpler to implement, more robust and, lastly, more reliable in comparison with the previously known technical solutions. Specifically, the cleaning assembly according to the first aspect of the invention dispenses with movable and controlled members for managing the discharge of the fluid, by proposing an architecture and a clever geometry.

Lastly, the cleaning assembly according to the first aspect of the invention proposes an economical solution to the technical problem mentioned above.

The cleaning assembly according to the first aspect of the invention advantageously comprises at least one of the refinements below, the technical features that make up these refinements being able to be considered alone or in combination:
the cleaning assembly comprises a slot delimited, for the one part, by the optical surface, and, for the other part, by the cleaning boom, the slot forming a through-opening in order to allow the fluid to flow through the slot. In particular, the slot forms a through-opening situated between the cleaning boom—and more particularly its strip—and the optical surface. In other words, the slot is located directly adjacent to an end of the optical surface. The slot can take any form. Advantageously, the slot has an oblong or rectangular form, and extends over all or part of an optical surface edge against which it is formed. This advantageous configuration makes it possible to effectively discharge the fluid running on the optical surface, avoiding the preservation of retention zones;
a width of the slot, measured as the smallest distance separating the cleaning boom from the optical surface, is greater than 0.5 mm, preferably greater than or equal to 1 mm. This advantageous configuration makes it possible for the fluid running on the optical surface to be discharged with a sufficient flow rate to avoid accumulation of said fluid at the border of the optical surface. A smaller width renders the invention ineffective because the desired discharge of the fluid running on the optical surface would be prevented by effects of capillary action resulting from this excessively small width. The width of the slot is preferably constant over the entire length of said slot;
the cleaning assembly according to the first aspect of the invention comprises a housing the at least one sensor, the housing comprising two lateral faces situated on either side of the signal emitted or received by the at least one sensor, the slot extending laterally between the two lateral faces of the housing. In other words, a longitudinal dimension of the slot, measured along its greatest length, is equal to a dimension of the housing measured between its two lateral faces, or possibly smaller than said dimension of the housing measured between its two lateral faces. The housing in this case forms a receptacle for each at least one sensor. In this case, the invention provides for the slot to be of sufficient extent to cover all or part of a housing width considered between the two lateral faces:
the housing comprises a base which extends between the two lateral faces, the optical surface forming an acute angle with the base. In other words, the optical surface does not form a right angle with the base. By contrast, the optical surface is inclined toward the rear, that is to say toward the at least one sensor incorporated in the housing, so as to form an inclined slope along which the fluid can run. As mentioned above, in the case of the presence of sufficient relative wind at the optical surface, resulting for example from a travel speed of the motor vehicle and/or from wind flowing around the motor vehicle, then the projected fluid present on the optical surface can be pushed toward an upper edge of the optical surface by the relative wind. The upper edge is in this case considered to be that edge of the optical surface which is proximal to an upper face of the housing, facing the base. As an alternative, if the relative wind is insufficient, the projected fluid present on the optical surface can flow toward a lower edge of the optical surface by the simple effect of gravity. The lower edge is in this case considered to be that edge of the optical surface which is proximal to the base of the housing. Thus, the angle formed between the optical surface and the base is preferably between 30° and 89°. According to a preferred embodiment, the angle formed between the optical surface and the base of the housing is equal to 78°;
more generally, the optical surface forms an acute angle with a horizontal plane of the motor vehicle, in which horizontal plane the cleaning assembly according to the first aspect of the invention is intended to be mounted. The horizontal plane considered in this case is a reference plane formed for example by the bearing points of the motor vehicle wheels when said motor vehicle is parked on a horizontal and planar terrain;
as an alternative, the optical surface may also form an obtuse angle with the base of the housing. In this embodiment variant, the optical surface is inclined toward the front, that is to say in a direction away from the sensor incorporated in the housing, so as to form an inclined slope. In other words, an upper edge of the optical surface, situated at an upper face of the housing, is situated farther in front of the at least one sensor incorporated in said housing than a lower edge of said optical surface. In this embodiment variant, in the case of the presence of sufficient relative wind at the optical surface, resulting for example from a travel speed of the motor vehicle and/or from wind flowing around the motor vehicle, as in the case of insufficient relative wind, then the projected fluid present on the optical surface can respectively be pushed by the relative wind or flow by the simple effect of gravity toward the lower edge of the optical surface. Thus, this embodiment variant cleverly makes it possible to better control the discharge of the fluid projected onto the optical surface since, in the two specific cases mentioned here, the fluid flows toward and through the slot, at the lower edge of the optical surface;
according to a first embodiment variant, the cleaning assembly comprises a support component which is not fastened directly to the at least one sensor, the cleaning boom being fastened securely to the support component, such that the slot is formed by an aperture provided between, for the one part, the support component and/or the cleaning boom, and, for the other part, the optical surface, The expression “not fastened directly” to the at least one sensor is understood to mean that the support component is fastened to a component that is separate from the sensor. In this first embodiment variant, the cleaning boom is not secured directly to the at least one sensor or its housing. This is the case, for example, if the cleaning boom is fastened to the support component, for which a structural chain for assembly on the motor vehicle is separate from the one for the at least one sensor or its housing. This may be the case, for example, if the at least one sensor is for example of the LIDAR type mounted on a first support component, and if the cleaning boom is mounted in the vicinity of the at least one sensor by way of a second support component, the first support component and the second support component being able to be secured to one another via one or more intermediate components. It will then be appreciated that, in this case, the position of the cleaning boom relative to the optical surface is more difficult to control, due to manufacturing and assembly tolerances;
according to a second embodiment variant, the cleaning assembly comprises a support plate fastened securely to the housing of the at least one sensor and to the cleaning boom, such that the slot is formed by an aperture provided between the cleaning boom and the optical surface. In this embodiment variant, the cleaning boom and the at least one sensor or its housing are secured to the same support plate, thus facilitating the assembly and the placing in position of the cleaning boom with respect to the optical surface;
according to a third, preferred embodiment variant, the cleaning boom is fastened securely to the housing of the at least one sensor, such that the slot is formed by an aperture provided between the cleaning boom and the optical surface. This third embodiment variant revises the most direct mechanical assembly, and the shortest possible kinematic and structural chain between the cleaning boom and the housing, thus ensuring a more precise assembly;
in the third embodiment variant, the cleaning boom is fastened securely to the housing by way of fastening tabs making it possible to hold the cleaning boom at the distance relative to the optical surface. In other words, the fastening tabs make it possible to fasten the cleaning boom with an overhang in relation to the housing, the cleaning boom not being situated in line with the fastening tabs. This advantageous configuration makes it possible to provide the necessary space between the cleaning boom and the optical surface in order to allow the fluid to flow;
according to a first embodiment of the third embodiment variant of the cleaning assembly, the fastening tabs of the cleaning assembly comprise a first fastening tab secured to a first lateral face of the housing, and a second fastening tab secured to a second lateral face of the housing, the second lateral face being opposite the first lateral face, relative to the signal emitted or received by the at least one sensor housed in the housing;
according to a second embodiment of the third embodiment variant of the cleaning assembly, the fastening tabs of the cleaning assembly comprise a first fastening tab and a second fastening tab which are secured to an upper face of the housing, the upper face being opposite the base of the housing, relative to the signal emitted or received by the at least one sensor, and connecting the two lateral faces of said housing;
according to a third embodiment of the third embodiment variant of the cleaning assembly, the fastening tabs of the cleaning assembly comprise a first fastening tab and a second fastening tab which are secured to the base of the housing;
in any one of the embodiments of the third embodiment variant of the cleaning assembly, each fastening tab comprises (i) a cylindrical bearing surface collaborating with a complementary cylindrical lug formed from the housing, and (ii) a prismatic bearing surface which protrudes from the cylindrical bearing surface toward the front, relative to the direction of propagation of the signal emitted or received by the at least one sensor, the cleaning boom being secured to a free end of the prismatic bearing surface;
the prismatic bearing surface and/or the cylindrical bearing surface of each fastening tab is situated at a distance from the housing. In other words, a face of the prismatic bearing surface and/or of the cylindrical bearing surface, situated facing the face of the housing to which the fastening tabs are fastened, are situated at a distance from said face of the housing, such that there is a non-zero space between said face of the bearing surface and said face of the housing. This advantageous configuration makes it possible to facilitate the flow of the fluid beyond the optical surface, and to avoid creating retention zones on the housing itself, in the vicinity of the optical surface and of the cleaning boom;
the slot extends between the fastening tabs of the cleaning boom;
the cleaning boom is situated facing a lower edge of the optical surface, the lower edge extending between the lateral faces of the housing and being situated on the side of the base of said housing. In this embodiment, the cleaning boom is situated at a lower part of the optical surface, and in particular facing its lower edge. In this configuration, placing the cleaning boom at a distance from the optical surface, and more particularly from its lower edge, makes it possible to prevent the fluid flowing by the effect of gravity along the optical surface from accumulating at the cleaning boom. By contrast, such a fluid running by gravity on the optical surface can now flow through the slot and the cleaning boom in order to be discharged toward a low point;
the cleaning boom is situated facing an upper edge of the optical surface, the upper edge extending between the lateral faces of the housing and being situated on the side of the upper face of said housing. In this configuration, placing the cleaning boom at a distance from the optical surface, and more particularly from its upper edge, makes it possible to prevent the fluid flowing by the effect of significant relative wind on the optical surface from accumulating at the cleaning boom and at an upper edge of the optical surface. By contrast, such a fluid running by aerodynamic effect on the optical surface can now flow through the slot and the cleaning boom in order to be discharged toward the upper face of the housing;
the cleaning boom is mounted immovably with respect to the at least one sensor and the optical surface;
the fluid projected by the cleaning boom onto the optical surface is of the type of a liquid and/or gaseous fluid.
the cleaning boom comprises a system for spraying the fluid. The spray system comprises one or more diffusion nozzles for projecting a cloud of cleaning liquid or a flow of air onto the optical surface;
according to a particularly clever embodiment of the invention, the system for spraying the fluid comprises a device for spraying a liquid onto the optical surface, and a device for projecting a layer of air onto the optical surface. Thus, in this embodiment, the invention combines both the use of the spray device projecting a cleaning liquid onto the optical surface and the device for projecting the layer of air in order to blow a flow of air onto the optical surface, making it possible to more easily remove the particles and the liquid present. Therefore, the presence of the cleaning boom situated at a distance from the optical surface makes it possible to aptly prevent the liquid projected onto the optical surface from subsequently falling back into the device for projecting the layer of air or into the device for spraying the liquid.

According to a second aspect of the invention, a motor vehicle is proposed comprising a cleaning assembly according to the first aspect of the invention or according to any one of its refinements.

Varying embodiments of the invention are foreseeable, incorporating the various optional features described here in all of their possible combinations.

### BRIEF DESCRIPTION OF DRAWINGS

Other features and advantages of the invention will become more clearly apparent from the description that follows and from a plurality of exemplary embodiments provided by way of non-limiting indication with reference to the appended schematic drawings, in which:

FIG. 1 illustrates a schematic view of a first embodiment variant of the cleaning assembly according to the first aspect of the invention;

FIG. 2 illustrates a schematic view of a second embodiment variant of the cleaning assembly according to the first aspect of the invention;

FIG. 3 illustrates a schematic view of a third embodiment variant of the cleaning assembly according to the first aspect of the invention;

FIG. 4 illustrates a schematic view of a third embodiment variant of the cleaning assembly according to the first aspect of the invention;

FIG. 5 illustrates a profile view of an exemplary embodiment of the cleaning assembly according to the second embodiment variant illustrated in FIG. 2;

FIG. 6 illustrates a first three-dimensional view of the cleaning assembly illustrated in FIG. 5; and

FIG. 7 illustrates a second three-dimensional view of the cleaning assembly illustrated in FIG. 5.

### DETAILED DESCRIPTION OF THE INVENTION

Of course, the features, variants and different embodiments of the invention can be combined with one another, in various combinations, provided that they are not incompatible or mutually exclusive. It will be possible, in particular, to imagine variants of the invention that comprise only a selection of the features described below, in isolation from the other features described, if this selection of features is sufficient to confer a technical advantage or to distinguish the invention from the prior art.

In particular, all of the variants and all of the embodiments described can be combined with one another if there is nothing preventing this combination from a technical perspective.

In the figures, elements that are common to several figures retain the same reference signs.

With reference to the FIGURES, the invention relates to a cleaning assembly 1 for a motor vehicle, the cleaning assembly 1 comprising:
at least one sensor 12;
   an optical surface 114 situated in front of the at least one sensor 12, relative to a direction of propagation of a signal emitted and/or received by said at least one sensor 12;
   a cleaning boom 13 configured to project a fluid onto the optical surface 114, the cleaning boom 13 being disposed at a distance d from the optical surface 114 so as to allow the fluid to flow between the at least one sensor 12 and the cleaning boom 13.

In the context of the invention, a plurality of configurations are foreseeable between the cleaning boom 13 and the at least one sensor 12. In particular, the cleaning boom 13 may be secured, directly or indirectly, to a housing 11 housing the at least one sensor 12.

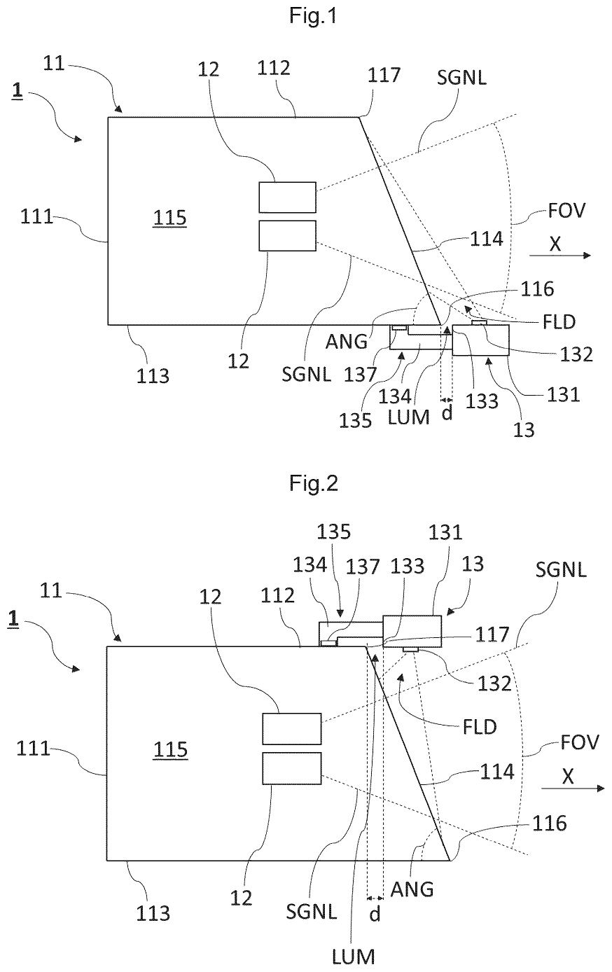

Secured directly to the housing is understood to mean that the cleaning boom 13 is integrally fixed to the housing 11, by way notably of fastening tabs 135. In this case, illustrated in FIG. 1 to FIG. 7, the distance d separating the fastening boom from the optical surface 114 is determined by the fastening tabs 135 and the mechanical connection connecting the cleaning boom 13 to the housing 11. This specific case will be described in more detail by means of a plurality of exemplary embodiments with reference to FIG. 1 to FIG. 4 in particular. In this specific case, the structural chain connecting the housing 11 to the cleaning boom 13 is shorter, thus enabling better control of the distance d separating the cleaning boom 13 from the optical surface 114.

By contrast, secured indirectly to the housing 11 is understood to mean that the cleaning boom 13 is connected to the housing 11 by way of an intermediate fastening component, such as a support plate to which both the cleaning boom 13 and the housing 11 are fastened. In this case, the structural chain connecting the housing 11 to the cleaning boom 13 is slightly longer, since it now passes through the support plate. This advantageous configuration thus makes it possible to propose a module formed simultaneously of the housing 11 housing the at least one sensor 12, the support plate and the cleaning boom.

In the context of the invention, the cleaning boom 13 and the housing 11 housing the at least one sensor 12, or even the at least one sensor 12 without the housing 11, can be placed in position with respect to one another without being connected to one another directly or by way of the support plate. By contrast, in this specific case, the cleaning boom 13 is secured to a first support component, whereas the at least one sensor 12 is secured to a second support component, separate from the first support component. The first support component and the second support component can then be connected to one another by a structural element of the motor vehicle on which the at least one sensor 12 and the cleaning boom 13 are mounted in order to collaborate together. In this specific case, the kinematic chain is longer and the at least one sensor 12 and the cleaning boom 13 form two separate modules mounted separately on the motor vehicle.

The two first cases are of course preferable, because they offer better performance resulting from better assembly precision, notably from control of the distance d separating the cleaning boom 13 from the optical surface 114.

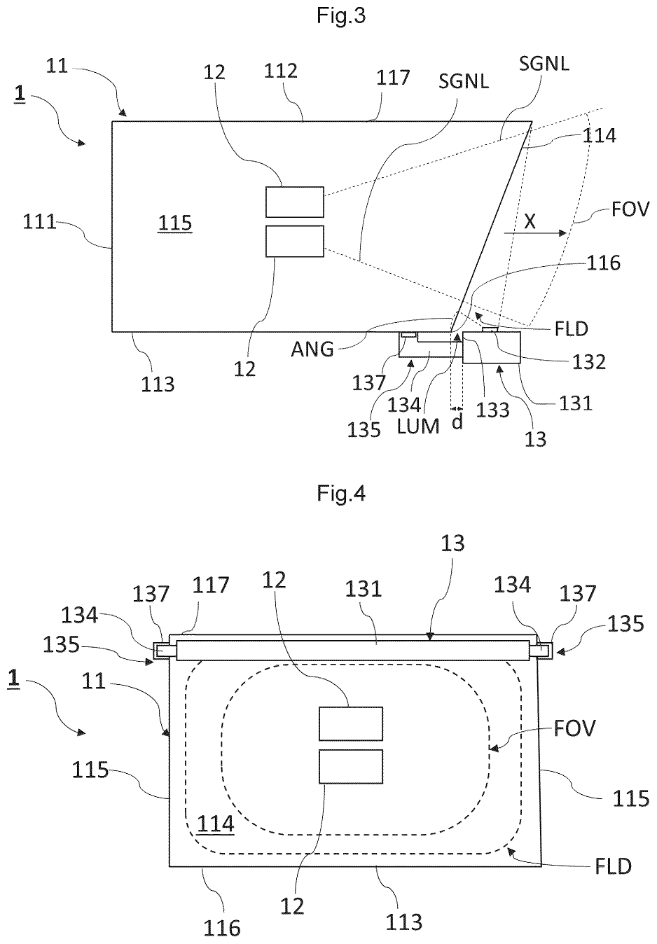

The preferred embodiment addresses the direct assembly of the cleaning boom 13 on the housing 11 housing the at least one sensor 12. This preferred embodiment is particularized in three embodiment variants illustrated schematically in FIG. 1 to FIG. 4:
as visible in FIG. 1 and FIG. 3, according to a first and a third exemplary embodiment, respectively, the fastening tabs 135 of the cleaning assembly 1 comprise a first fastening tab 135 and a second fastening tab 135 which are secured to the base 113 of the housing 11. Thus, the cleaning boom 13 is situated at a lower part of the cleaning assembly 1 according to the invention, and the distance d provided between the cleaning boom 13 and the optical surface 114 allows the fluid running on the optical surface 114 to flow off of said optical surface 114 by the simple effect of gravity without being hindered by the cleaning boom 13. In the exemplary embodiment visible in FIG. 1, the optical surface extends toward the rear, toward the at least one sensor 12 and forming an acute angle ANG with the base 113. In the exemplary embodiment visible in FIG. 3, the optical surface extends toward the front, in a direction away from the at least one sensor 12 and forming an obtuse angle ANG with the base 113;
as visible in FIG. 2 and according to a second exemplary embodiment, the fastening tabs 135 of the cleaning assembly 1 comprise a first fastening tab 135 and a second fastening tab 135 which are secured to an upper face 112 of the housing 11, the upper face 112 being opposite the base 113 of the housing 11, relative to the signal emitted or received by the at least one sensor 12, and connecting the two lateral faces 15 of said housing 11. Thus, the cleaning boom 13 is situated at an upper part of the cleaning assembly 1 according to the invention, and the distance d provided between the cleaning boom 13 and the optical surface 114 allows the fluid running on the optical surface 114 under the effect of an aerodynamic flow resulting from sufficient relative wind at the optical surface 114 to flow off of said optical surface 114 without being hindered by the cleaning boom 13;
as visible in FIG. 3 and according to a third exemplary embodiment, the fastening tabs 135 of the cleaning assembly 1 comprise a first fastening tab 135 secured to a first lateral face 115 of the housing 11, and a second fastening tab 135 secured to a second lateral face 115 of the housing 11, the second lateral face 115 being opposite the first lateral face 115, relative to the signal emitted or received by the at least one sensor 12 housed in the housing 11. In this third exemplary embodiment, the cleaning boom 13 can be situated without preference at an upper part or a lower part of the optical surface 114.

In all the exemplary embodiments illustrated, the cleaning boom 13 is advantageously placed outside the field of view FOV of the at least one sensor 12, so as to not have a limiting impact on the latter.

In addition, the cleaning boom 13 is provided in such a way that the projected fluid FLD covers at least all of the part of the optical surface 114 that is covered by the field of view FOV of the at least one sensor 12, in order to ensure proper cleaning and optimal operation of said at least one sensor 12.

As visible in FIG. 1 to FIG. 7, the cleaning boom 13 is not adhesively bonded against the optical surface 114. By contrast, the cleaning boom 13 is situated at the distance d from the optical surface 114, such that there is a non-zero clearance between a facing face 133 of the cleaning boom 13 proximal to the optical surface 114 and said optical surface 114.

More particularly, the cleaning assembly 1 comprises a slot LUM delimited, for the one part, by the optical surface 114, and, for the other part, by the cleaning boom 13, the slot LUM forming a through-opening in order to allow the fluid to flow through the slot LUM. The slot LUM thus forms a through-opening situated between the cleaning boom 13—and more particularly its strip 131 and the optical surface 114. The slot LUM is located directly adjacent to a lower edge 116 of the optical surface 114, as visible in FIG. 1, or an upper edge 117 of the optical surface 114, as visible in FIG. 2, or, in general, to any part of the optical surface 114.

The slot LUM can take any form and preferably extends from one lateral edge to the other of the cleaning boom 13 and of the strip 131.

A width of the slot LUM, forming the smallest distance d separating the facing face 133 of the cleaning boom 13 and the optical surface 114, is greater than 0.5 mm, preferably greater than or equal to 1 mm. As visible in the FIGURES, the width of the slot LUM is preferably constant over the entire length of said slot LUM, along the strip 131 and the optical surface 114.

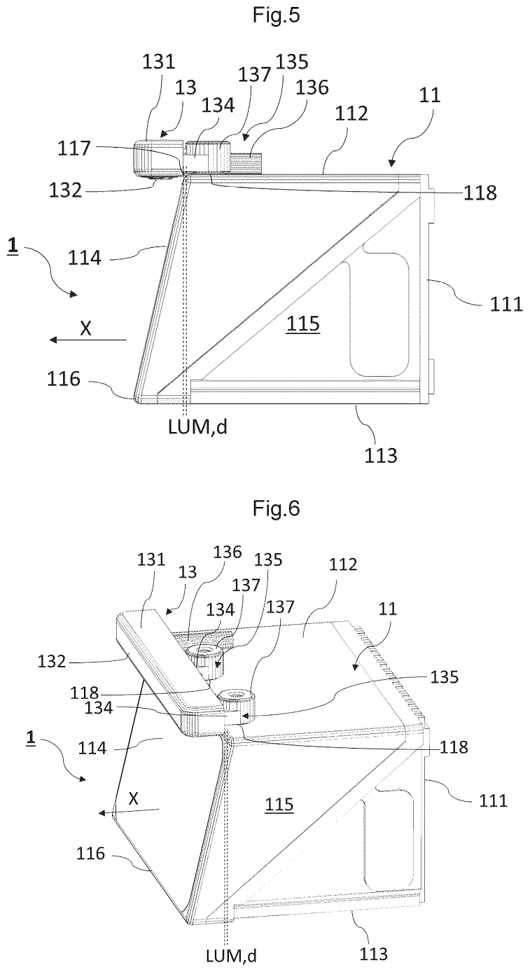

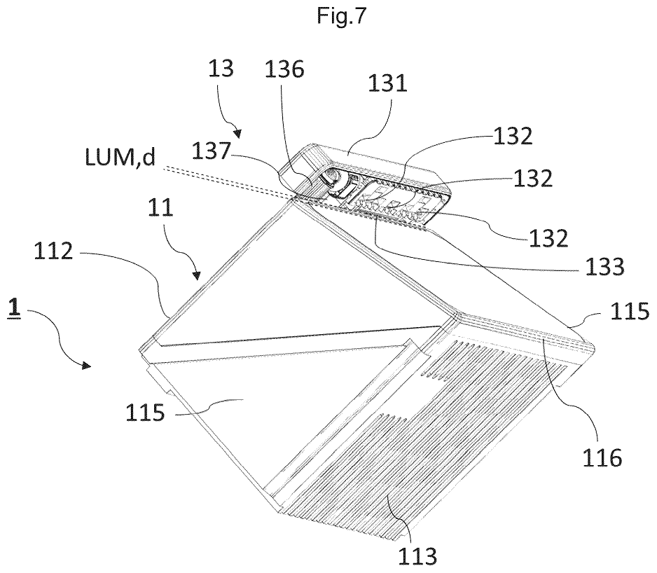

As visible in FIG. 1 to FIG. 7, and more specifically in FIG. 5, FIG. 6, and FIG. 7, the housing 11 has a prismatic general form and comprises two lateral faces 15 situated on either side of the signal emitted or received by the at least one sensor 12. The housing 11 also comprises a base 113 which extends between the two lateral faces 15, and an upper face 112 situated facing the base 113, such that the lateral faces 15, the base 113 and the upper face 112 together form a receptacle for the at least one sensor 12.

In the context of the invention, the optical surface 114 can adopt any configuration with respect to the base 113:
in the exemplary embodiment illustrated in FIG. 1, relative to the base 113, the optical surface 114 forms an acute angle ANG, the optical surface 114 being inclined toward the rear, that is to say toward the at least one sensor 12 incorporated in the housing 11 and a rear face 111 of said housing 11, so as to form an inclined slope along which the fluid FLD projected by the cleaning boom 13 can run. Thus, the angle ANG formed between the optical surface 114 and the base 113 is preferably between 30° and 89°. According to a preferred embodiment illustrated in FIG. 5 to FIG. 7, the angle ANG formed between the optical surface 114 and the base 113 of the housing 11 is equal to 78°;
   in the exemplary embodiment illustrated in FIG. 3, relative to the base 113, the optical surface 114 forms an obtuse angle ANG, the optical surface 114 being inclined toward the front, in a direction away from the at least one sensor 12 incorporated in the housing 11. Thus, the angle ANG formed between the optical surface 114 and the base 113 is preferably between 90° and 140°, and preferably between 100° and 120°.
The optical surface 114 has a rectangular general form and it is delimited by a lower edge 116 and an upper edge 117, which are rectilinear and preferably parallel in the exemplary embodiments illustrated in the FIGURES.

Thus, in the case of the presence of sufficient relative wind at the optical surface 114, resulting for example from a travel speed of the motor vehicle and/or from wind flowing around the motor vehicle, then the fluid FLD projected by the cleaning boom 13 and present on the optical surface 114 can be pushed toward the upper edge 117 of the optical surface 114 by the relative wind. As an alternative, if the relative wind is insufficient, the fluid FLD projected by the cleaning boom 13 and present on the optical surface 114 can flow toward the lower edge 116 of the optical surface 114 by the simple effect of gravity.

In accordance with the invention, the cleaning boom 13 is situated at the distance d from the optical surface 114, regardless of the position of the cleaning boom 13 with respect to the optical surface 114. This distance d is expressed in particular relative to a longitudinal direction delimited overall by a mean direction of propagation of the signal emitted or signal received SGNL by the at least one sensor 12. This direction corresponds generally to a longitudinal axis X of the motor vehicle which extends from the rear to the front.

Thus, the facing face 133 of the cleaning boom 13 situated facing the optical surface 114 and forming the slot LUM through which the fluid can flow extends parallel to the optical surface 114 or in such a way that the distance d between said facing face 133 and said optical surface 114 is constant for the entirety of said slot LUM.

In the exemplary embodiment illustrated in FIG. 5 to FIG. 7, the cleaning boom 13 is integrally fixed to the housing 11 by way of fastening tabs 135 making it possible to hold the cleaning boom 13 at the distance d relative to the optical surface 114 and to thus form the slot LUM described above. In other words, the fastening tabs 135 position the cleaning boom 13 with an overhang in relation to the housing 11 and the optical surface 114.

In order to provide optimal cleaning of the optical surface 114, the cleaning boom 13 is not situated in line with the fastening tabs 135. By contrast, in a transverse plane considered to be parallel to the lateral faces 15 of the housing 11, the cleaning boom 13 is situated in an intermediate position between the upper edge 117 and the lower edge 116 of the optical surface 114, relative to the longitudinal axis X.

Furthermore, in accordance with the invention, there is a non-zero distance d, measured relative to the longitudinal axis X, between the facing face 133 of the strip 131 and the upper edge 117 or the lower edge 116 of the optical surface 114.

As visible in FIG. 5 to FIG. 7, each fastening tab 135 comprises (i) a cylindrical bearing surface 137 collaborating with a complementary cylindrical lug 118 formed from the housing 11, and (ii) a prismatic bearing surface 134 which protrudes from the cylindrical bearing surface 137 toward the front, relative to the direction of propagation of the signal emitted or received by the at least one sensor 12, the cleaning boom 13 being secured to a free end of the prismatic bearing surface 134. In addition, as visible in FIG. 5 in particular, the prismatic bearing surface 134 and the cylindrical bearing surface 137 of each fastening tab 135 are not in contact with the housing 11, and in particular the upper face 112 of said housing 11 in the exemplary embodiment illustrated in FIG. 5.

In order to enable the fluid to be sprayed onto the optical surface 114, the cleaning boom 13 comprises a spray system 132 which comprises one or more diffusion nozzles which make it possible to project a cloud of cleaning liquid and/or a flow of air onto the optical surface 114. The fluid FLD projected onto the optical surface 114 is conveyed via a distribution line 136 coupled to the strip 131 and to the diffusion nozzles.

In short, the invention relates to a clever geometry for a housing 11 housing a sensor 12, such as a LIDAR, and a cleaning boom 13 which is used to project a fluid used to clean an optical surface 114 of the housing 11 or of the sensor 12 onto said optical surface 114. Cleverly, the cleaning boom 13 is not adhesively bonded to the optical surface 114, but situated at the distance d from the optical surface 114, such that there is a non-zero clearance, forming a slot LUM, between the cleaning boom 13 and the optical surface 114 in order for the projected fluid FLD flowing on the optical surface 114 to be able to be discharged from the optical surface 114 by flowing through the slot LUM thus formed.

Of course, the invention is not limited to the examples which have just been described, and numerous modifications may be made to these examples without departing from the scope of the invention. In particular, the various features, forms, variants and embodiments of the invention can be combined with one another, in various combinations, as long as they are not incompatible or mutually exclusive. In particular, all the variants and embodiments described above can be combined with one another.

What is claimed is:

1. A cleaning assembly for a motor vehicle, the cleaning assembly comprising:
at least one sensor;
an optical surface situated in front of the at least one sensor, relative to a direction of propagation of a signal emitted and/or received by the at least one sensor;
a cleaning boom configured to project a fluid onto the optical surface; wherein the cleaning boom is disposed at a distance from the optical surface so as to allow the fluid to flow between the at least one sensor and the cleaning boom.

2. The cleaning assembly as claimed in claim 1, wherein the cleaning assembly includes a slot delimited by the optical surface and the cleaning boom, the slot forming a through-opening in order to allow the fluid to flow through the slot.

3. The cleaning assembly as claimed in claim 2, wherein the cleaning assembly includes a housing that houses the at least one sensor, the housing includes two lateral faces situated on either side of the signal emitted or received by the at least one sensor, the slot extending laterally between the two lateral faces of the housing.

4. The cleaning assembly as claimed in claim 1, wherein the cleaning boom is mounted immovably with respect to the at least one sensor and the optical surface.

5. The cleaning assembly as claimed in claim 3, wherein the cleaning assembly includes a support plate integrally fixed to the housing of the at least one sensor and to the cleaning boom, such that the slot is formed by an aperture provided between the cleaning boom and the optical surface.

6. The cleaning assembly as claimed in claim 2, wherein the cleaning assembly includes a support component which is not integrally fixed to the at least one sensor, the cleaning boom being fastened securely to the support component, such that the slot is formed by an aperture provided between the support component and/or the cleaning boom and the optical surface.

7. The cleaning assembly as claimed in claim 2, wherein the cleaning boom is fastened to a support component, for which a structural chain for assembly on the motor vehicle is separate from the one for the at least one sensor or for a housing the at least one sensor.

8. The cleaning assembly as claimed in claim 3, wherein the cleaning boom is integrally fixed to the housing of the at least one sensor, such that the slot is formed by an aperture provided between the cleaning boom and the optical surface.

9. The cleaning assembly as claimed in claim 8, wherein the cleaning boom is integrally fixed to the housing by way of fastening tabs and allowing the cleaning boom to be held distance relative to the optical surface.

10. The cleaning assembly as claimed in the claim 9, wherein the fastening tabs of the cleaning assembly includes a first fastening tab and a second fastening tab which are secured to an upper face of the housing, the upper face being opposite a base of the housing, relative to the signal emitted or received by the at least one sensor, and connecting the two lateral faces of the housing.

11. The cleaning assembly as claimed in claim 10, wherein each fastening tab includes:
a cylindrical bearing surface collaborating with a complementary cylindrical lug formed from the housing; and
a prismatic bearing surface which protrudes from the cylindrical bearing surface toward the front, relative to the direction of propagation of the signal emitted or received by the at least one sensor, the cleaning boom being secured to a free end of the prismatic bearing surface.

12. The cleaning assembly as claimed in claim 1, wherein the cleaning boom includes a system for spraying the fluid, the system for spraying the fluid includes a device for spraying a liquid onto the optical surface, and a device for projecting a layer of air onto the optical surface.

13. A motor vehicle comprising a cleaning assembly, the cleaning assembly includes at least one sensor, an optical surface situated in front of the at least one sensor, relative to a direction of propagation of a signal emitted and/or received by the at least one sensor, a cleaning boom configured to project a fluid onto the optical surface, and wherein the cleaning boom is disposed at a distance from the optical surface so as to allow the fluid to flow between the at least one sensor and the cleaning boom.
